(19) United States
(12) Patent Application Publication
(10) Pub. No.: US 2007/0207928 A1
(43) Pub. Date: Sep. 6, 2007

(54) Oil-in-water suspoemulsions comprising hydroxybenzonitriles which are active in plants

(75) Inventors: Gerhard Frisch, Wehrheim (DE); Janine Rude, Kriftel (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience GmbH, Frankfurt (DE)

(21) Appl. No.: 11/448,768

(22) Filed: Jun. 8, 2006

(30) Foreign Application Priority Data
Jun. 10, 2005 (EP) 05012496.5

(51) Int. Cl. A01N 43/64; A01N 25/04; A01N 25/16

(52) U.S. Cl. 504/133; 504/364

(57) ABSTRACT

The present invention relates to the field of the plant protection formulations. In particular, the invention relates to formulations in the form of oil-in-water suspoemulsions (o/w suspoemulsions) which comprise one or more herbicidal active substances from the group of the hydroxybenzonitriles and at least one further agrochemical active substance which does not belong to the group of the hydroxybenzonitriles, the formulations being free of alkylphenol polyethoxylates, and naphthalene being present in an amount of less than 0.5%. The suspoemulsions according to the invention are suitable for controlling undesired vegetation.

The present invention relates to the field of the plant protection formulations. In particular, the invention relates to formulations in the form of oil-in-water suspoemulsions (o/w suspoemulsions) which comprise one or more herbicidal active substances from the group of the hydroxybenzonitriles and at least one further agrochemical active substance which does not belong to the group of the hydroxybenzonitriles, the formulations being free of alkylphenol polyethoxylates, and naphthalene being present in an amount of less than 0.5%.

Suspoemulsions per se are known and are suitable as preferred formulation variant for a variety of applications when a variety of active substances in dissolved and dispersed form are to be combined in one system. Applications of suspoemulsions (o/w=oil-in-water, but also w/o=water-in-oil) are, for example, in the field of cosmetic substances, pharmaceutical substances, substances used in veterinary medicine and agrochemical substances (described, inter alia, in EP 0 514 768), but also in the field of the hygiene articles and detergents, and in the color and paint sector. Suspoemulsions simplify metering and avoid the necessity of providing combination preparations (combi-packs).

Herbicidal active substances are generally not employed in pure form. Depending on the field and type of application, and on physical, chemical and biological parameters, the active substances are employed as an active substance formulation, in admixture with customary adjuvants and additives. The combinations with further active substances for widening the spectrum of action and/or for protecting the crop plants (for example by safeners) or else with agrochemical active substances which are directed against, for example, pests, are also known.

In plant protection in general, agrochemical active substances from the field of the insecticides, herbicides, fungicides and acaricides can thus be formulated readily and in a meaningful manner in the form of suspoemulsions.

Formulations of herbicidal active substances should generally be distinguished by high chemical and physical stability, good applicability and user friendliness and a broad biological effect combined with high selectivity. As an example of a herbicidal active substance from the group of the hydroxybenzonitriles, bromoxynil (3,5-dibromo-4-hydroxybenzonitrile) is used in combination with terbuthylazin (N²-tert-butyl-6-chloro-N⁴-ethyl-1,3,5-triazine-2,4-diamine) as aqueous suspoemulsion (for example Gardobuc®). The disadvantage of the formulations on which these products are based is the fact that they comprise, inter alia, nonionic surfactants from the group of the alkylphenol polyethoxylates (APEs) and naphthalenes which are only slowly degraded after their release, in a manner per se and in the form of their degradation products. Regarding its physical characteristics, this formulation is highly viscous, forms a number of agglomerations and sediments upon storage.

EP-A-0261492 describes, inter alia, suspoemulsions of the abovementioned active substance combination which comprise naphthalene-comprising solvents so that the naphthalene content of the resulting formulation exceeds 0.5%. Thus, it is known for example that a replacement of naphthalene-comprising solvents by low-naphthalene solvents may lead, or leads, to radically altered solution and emulsion properties. As a result, the consequence may be that existing surfactant compositions no longer ensure the ability of being formulated.

To avoid the abovementioned disadvantages, the object of the present invention was to provide a technically alternative, or, if appropriate, advantageous, plant protection formulation in the form of an o/w suspoemulsion (o/w=oil-in-water) for active substances from the group of the hydroxybenzonitriles such as, for example, bromoxynil, or ioxynil, and other agrochemical substances, which formulation is free from alkylphenol polyethoxylates and/or naphthalene-comprising solvents (i.e. solvents comprising <0.5% naphthalene).

This object is achieved by providing an o/w suspoemulsion comprising (i) at least one herbicidally active substance from the group of the hydroxybenzonitriles (such as, for example, bromoxynil, or ioxynil), (ii) one or more agrochemical active substance(s) other than (i), and (iii) a combination of one or more ethoxylated tridecyl alcohols, one or more dodecylbenzenesulfonic acid salts, one or more thickeners and (iv) if appropriate further adjuvants and additives.

The present invention thus relates to o/w suspoemulsions comprising (i) at least one herbicidally active substance from the group of the hydroxybenzonitriles (such as, for example, bromoxynil, or ioxynil), (ii) one or more agrochemical active substance(s) other than (i), and (iii) a combination of one or more ethoxylated tridecyl alcohols, one or more dodecylbenzenesulfonic acid salts, one or more thickeners and (iv) if appropriate further adjuvants and additives.

The suspoemulsions according to the invention are distinguished by an outstanding storage stability. They are storage-stable for at least 2 years at room temperature, no crystal growth being observed during this period.

In a preferred embodiment, the suspoemulsions comprise
a) 0.1 to 50% of one or more hydroxybenzonitriles which have an effect in plants,
b) 0.1 to 15% of one or more ethoxylated tridecyl alcohols comprising 2-50, preferably 3-20, very especially preferably 4-12 ethylene oxide units (EO),
c) 0.01 to 10% of one or more dodecylbenzenesulfonic acid salts,
d) 0.01 to 2% of one or more thickeners,
e) 0.1 to 45% of one or more other agrochemical active substances other than a),
f 0.1 to 35% of adjuvants and additives, and
g) 20 to 50% of water.

Especially preferred are suspoemulsions according to the invention comprising:
a) 0.5 to 40% of one or more hydroxybenzonitriles which have an effect in plants,
b) 2.0 to 12% of one or more ethoxylated tridecyl alcohols comprising 2-50, preferably 3-20, very especially preferably 4-12 ethylene oxide units (EO),
c) 0.1 to 5% of one or more dodecylbenzenesulfonic acid salts,
d) 0.02 to 1.2% of one or more thickeners,
e) 3.5 to 40% of one or more other agrochemical active substances other than a),
f) 0.15 to 12% of adjuvants and additives, and
g) 20 to 50% of water.

Also especially preferred are suspoemulsions according to the invention comprising:
a) 0.5 to 32% of one or more hydroxybenzonitriles which have an effect in plants,
b) 4 to 10% of one or more ethoxylated tridecyl alcohols comprising 2-50, preferably 3-20, very especially preferably 4-12 ethylene oxide units (EO),
c) 0.2 to 2% of one or more dodecylbenzenesulfonic acid salts,
d) 0.05 to 0.8% of one or more thickeners,
e) 3.5 to 40% of one or more other agrochemical active substances other than a),
f) 0.15 to 12% of adjuvants and additives, and
g) 20 to 50% of water.

All the percentage data given above are percent by weight [wt. %].

The ranges, of the individual groups of substances of the suspoemulsions according to the invention, which have been mentioned above as being preferred can be combined with each other as desired.

As regards the abovementioned component (a), preferred substances from the group of the hydroxybenzonitriles which are active in plants are bromoxynil or ioxynil, both of which can be present for example in the form of their esters (heptanoate, octanoate and/or butyrate) or else as the potassium salt (bromoxynil) or the sodium salt (ioxynil), very especially bromoxynil in the form of the heptanoate, octanoate or as the potassium salt, or mixtures of the esters, or else mixtures of the esters with the sodium salt, or potassium salt, of the hydroxybenzonitrile in question.

Suitable as the abovementioned component b) are commercially available tridecyl alcohols having 2-50 ethylene oxide units (EO). Products which may be mentioned in this context by way of example are Rhodasurf® (Rhodia), Lutensol® (BASF) and Genapol® X (Clariant).

Suitable as the abovementioned component c) are, for example, commercially available calcium dodecylbenzenesulfonates or isopropylamine dodecylbenzene-sulfonates, which can be dissolved in solvents such as isopropanol, ocatanol or Solvesso™. Examples which may be mentioned in this context are Libramul IPA™ (Libra Chemicals), Ca-70® (Clariant) and Rhodacal® (Rhodia).

Examples of suitable thickeners (component d)) are
1) modified natural silicates such as chemically modified bentonites, hectorites, attapulgites, montmorillonites, smectites or other silicate minerals, such as Bentone® (Elementis), Attagel® (Engelhard), Agsorb® (Oil-Dri Corporation) or Hectorite™ (Akzo Nobel)
2) synthetic silicates such as silicates from the Sipernat®, Aerosil® or Durosil® series (Degussa), from the CAB-O-SIL® series (Cabot) or the Van Gel series (R.T. Vanderbilt),
3) thickeners based on synthetic polymers such as thickeners from the Thixin® or Thixatrol® series (Elementis) and Rhodopol® (Rhodia) and Keizan® S (Kelco Corp.).

Thickeners from the group of the bentonites are preferred.

Examples of suitable agrochemical active substances of group e) are (the IUPAC name of the active substance in question is given in brackets):
a) active substances from the class of the 1,3,5-triazines and the 1,2,4-triazinones such as, for example, ametryn (N²-ethyl-N⁴-isopropyl-6-methylthio-1,3,5-triazine-2,4-diamine), atrazine (6-chloro-N²-ethyl-N⁴-isopropyl-1,3,5-triazine-2,4-diamine), aziprotryne (4-azido-N-isopropyl-6-methylthio-1,3,5-triazine-2,4-diamine), cyanazine (2-[4-chloro-6-(ethylamino)-1,3,5-triazine-2-ylamino), methoprotryne (N²-isopropyl-N⁴-(3-methoxypropyl)-6-methylthio-1,3,5-triazine-2,4-triazine), metribuzine (4-amino-6-tert-butyl-3-methylthio-1,2,4-triazine-5(4H)-one), prometryn (N², N⁴-diisopropyl-6-methylthio-1,3,5-triazine-2,4,diamine), prometon (N², N⁴-diisopropyl-6-methoxy-1,3,5-triazine-2,4-diamine, propazine (6-chloro-N², N⁴-diisopropyl-1,3,5-triazine-2,4-diamine), simetryn (N², N⁴-diethyl-6-methylthio-1,3,5-triazine-2,4-diamine), simazine (6-chloro-N², N⁴-diethyl-1,3,5-triazine-2,4-diamine), terbuthylazine (N²-tert-butyl-6-chloro-N⁴-ethyl-1,3,5-triazine-2,4-diamine), terbutryn (N²-tert-butyl-N⁴-ethyl-6-methylthio-1,3,5-triazine-2,4-diamine) and trietazine (6-chloro-N², N², N⁴-triethyl-1,3,5-triazine-2,4-diamine), of which atrazine, simazine and terbuthylazine are preferred, atrazine and terbuthylazine especially preferred and terbuthylazine very especially preferred;
b) active substances based on triketones, such as mesotrione (2-(4-mesyl-2-nitrobenzoyl)cyclohexane-1,3-dione) and sulcotrione (2-(2-chloro-4-mesylbenzoyl)cyclohexane-1,3-dione);
c) active substances based on aryloxyalkanoic acid, such as 2,4-D (2,4-dichlorophenoxy)acetic acid);
   and in each case their derivatives in the form of acids or esters. These active substance are known for example from “The Pesticide Manual”, 12th edition (2000), The British Crop Protection Council.

The further adjuvants and additives f) are, for example, solvents such as naphthalene-free Solvesso™, xylene, alkylbenzenes, antifreeze agents, antifoams, structure-imparting substances, preservatives, colorants, perfumes, wetters, anti-drift agents, stickers, penetrants, antioxidants and further surfactants.

Suitable antifreeze agents are those from the group of the ureas, diols and polyols, such as ethylene glycol and propylene glycol.

Suitable antifoams are those based on silicones.

Suitable structure-imparting substances are those from the group of the xanthans.

Suitable preservatives, colorants and perfumes are known to the skilled worker.

Examples of suitable further surfactants are emulsifiers and dispersants such as
1) polyalkoxylated, preferably polyethoxylated, emulsifiers/dispersants which are ionically modified, for example by converting the terminal free hydroxyl function of the polyethylene oxide block into a sulfate or phosphate ester (for example as the alkali and alkaline-earth metal salts), such as, for example, Genapol®LRO or Dispergiermittel 3618 (Clariant), Emulphor® (BASF) or Crafol®AP (Cognis),
2) alkali and alkaline-earth metal salts of alkylarylsulfonic acids having a linear or branched alkyl chain, such as Phenylsulfonat CA or Phenylsulfonat CAL (Clariant), Atlox® 3377BM (ICI), Empiphos®TM series (Huntsman),
3) polyelectrolytes such as lignosulfonates, condensates of naphthalenesulfonate and formaldehyde, polystyrenesulfonate or sulfonated unsaturated or aromatic polymers (polystyrene, polybutadienes or polyterpenes), such as Tamol® series (BASF), Morwet®D425 (Witco), Kraftsperse® series (Westvaco), Borresperse® series (Borregard).

The abovementioned formulation auxiliaries of groups b), c), d) and f) are known to the skilled worker and are described for example in: Watkins, “Handbook of Insecticide Dust Diluents and Carriers”, 2nd Ed., Darland Books, Caldwell N. J.; H. v. Olphen, “Introduction to Clay Colloid Chemistry”; 2nd Ed., J. Wiley & Sons, N.Y.; C. Marsden, “Solvents Guide”; 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte” [Interface-active ethylene oxide adducts], Wiss. Verlagsgesell., Stuttgart 1976; Winnacker-Küchler, “Chemische Technologie” [Chemical engineering], volume 7, C. Hauser Verlag Munich, 4th Ed. 1986, in H. Mollet and A: Grubenmann, “Formulierungstechnik” [Formulation technology], Wiley-VCH-Verlag GmbH, 2000.

For use, the suspoemulsions according to the invention can be diluted in the customary manner, for example by means of water. It may be advantageous to add, to resulting spray mixtures, further agrochemical active substances (for example components for tank mixers in the form of suitable formulations) and/or adjuvants and additives which are usually employed, for example autoemulsifying oils such as vegetable oils or liquid paraffin and/or fertilizers. The present invention therefore relates to those herbicidal compositions which are based on the suspoemulsions according to the invention.

The herbicidal compositions have an outstanding herbicidal activity against a broad spectrum of economically important harmful plants. They even provide good control of perennial problem weeds which produce shoots from rhizomes, rootstocks or other perennial organs. In this context, the compositions can be applied for example before sowing, pre-emergence or post-emergence. Some representatives of the weed flora which can be controlled by the herbicidal compositions according to the invention may be mentioned individually by way of example, without the mention implying a restriction to certain species.

Thus, good control is effected when using the suspoemulsions according to the invention, for example, Abutilon theophrasti, Amaranthus spp., Ambrosia spp, Chenopodium album, Conyza canadensis, Datura stramonium, Euphorbia dentata, Helianthus annus, Hibiscus trionum, Ipomoea spp., Jacquemontia tamnifolia, Kochia scoparia, Phytolacca americana, Polygonum spp. Sesbania exaltata, Sida spinosus, Sinapis arvensis, Solanum spp., Tribulus terrestris, Xanthium strumarium, it being possible for the efficiency of the individual weeds to vary depending on the selected components (a) and (e).

If the herbicidal compositions according to the invention are applied to the surface of the soil before germination, either the emergence of the weed seedlings is prevented completely or else the weeds grow until they have reached the cotyledon stage, but then their growth stops and, eventually, after three to four weeks have elapsed, they die completely.

When applying the herbicidal compositions according to the invention post-emergence, growth likewise stops drastically very soon after the treatment, and the weed plants remain at the growth stage of the point in time of application, or they die completely after a certain time has elapsed, so that, in this manner, competition by weeds, which is harmful to the crop plants, is eliminated at a very early point in time and in a sustained manner.

The herbicidal compositions according to the invention are distinguished by a prolonged herbicidal activity with a rapid onset. The rainfastness of the active substances in the combinations according to the invention is, as a rule, favorable. A particular advantage is that the effective dosages of herbicidal compounds which are used in the herbicidal compositions can be set at such a low level that their soil activity is optimally low. This not only makes their use possible in the first place in sensitive crops, but contaminations of the groundwater are virtually avoided. The combination according to the invention of active substances makes possible a substantial reduction of the required application rate of the active substances.

The abovementioned properties and advantages are useful in weed control practice for keeping agricultural crops free from undesired plant competitors and thus for safeguarding the quality and quantity of the yields and/or for increasing them. These novel compositions markedly outperform the technical standard with regard to the above-described properties.

The herbicidal compositions according to the invention are highly suitable for the selective control of undesired vegetation in plantings of agricultural crops or in ornamental plantings, in particular in crop plants of economically important graminaceous crops such as wheat, barley, rye, oats, sorghum/millet, maize and turf, but also in crops such as, for example, onions, leeks, garlic, flax, sugar cane, all of which only suffer insignificant damage or none at all.

In addition, the herbicidal compositions according to the invention have outstanding growth-regulatory properties in crop plants. They engage in the plants' metabolism in a regulatory fashion and can therefore be used for influencing plant constituents in a targeted manner and for facilitating harvesting, such as, for example, by triggering desiccation and stunted growth. Moreover, they are also suitable for generally controlling and inhibiting undesired vegetative growth without destroying the plants in the process.

As a result of the herbicidal and plant-growth-regulatory properties, the herbicidal compositions according to the invention can also be employed for controlling harmful plants in crops of genetically modified plants which are known or yet to be developed. The transgenic plants are, as a rule, distinguished by particularly advantageous properties, for example by resistances to certain pesticides, especially certain herbicides, resistances to plant diseases or pathogens of plant diseases, such as certain insects or microorganisms such as fungi, bacteria or viruses. Other particular properties concern for example the harvested crop with regard to the quantity, quality, shelf life, composition and specific constituents. Thus, transgenic plants with an increased starch content or a modified starch quality, or others with a different fatty acid composition of the harvested crop are known.

The herbicidal compositions according to the invention are preferably used in economically important transgenic crops of useful plants and ornamentals, for example of graminaceous crops such as wheat, barley, rye, oats, sorghum/millet and maize, but also in crops such as, for example, onions, leeks, garlic, flax, sugar cane. The compositions according to the invention can preferably be employed as herbicides in crops of useful plants which are resistant, or have been made resistant as the result of recombinant techniques, to the phytotoxic effects of the herbicides.

When using the herbicidal compositions according to the invention in transgenic crops, effects are frequently observed, in addition to the effects regarding harmful plants which can be observed in other crops, which are specific for the application in the transgenic crop in question, for example a modified or specifically widened weed spectrum which can be controlled, altered application rates which can be employed for the application, preferably good combining ability with the herbicides to which the transgenic crop is resistant, and an effect on growth and yield of the transgenic crop plants.

The present invention furthermore also relates to a method of controlling undesired vegetation, preferably in crop plants such as cereals (for example wheat, barley, rye, oats, maize, sorghum/millet and sugar cane, onions, leeks, garlic, flax, especially preferably in monocotyledonous crops such as cereals, for example, wheat, barley, rye, oats, their crosses such as triticale, rice, maize and sorghum/millet, especially preferably in maize, in which process one or more herbicidal compositions according to the invention are applied to the harmful plants, plant parts, plant seeds or the area on which the plants grow, for example the area under cultivation.

The suspoemulsions according to the invention are prepared in two steps and are carried out in a manner with which the skilled worker is familiar, for example by wet-grinding by means of a bead mill; see, in this context, Winnacker-Küchler, “Chemische Technologie” [Chemical engineering], volume 7, C. Hanser Verlag Munich, 4th Ed. 1986, Wade van Valkenburg, “Pesticide Formulations”, Marcel Dekker, N.Y., 1973; K. Martens, “Spray Drying” Handbook, 3rd Ed. 1979, G. Goodwin Ltd. London.

To prepare the examples mentioned in table 1, the agrochemical active substances are first synthesized together with the selected adjuvants by finely grinding them, using suitable bead mills. Thereafter, the organic phase comprising solvent, agrochemical active substances and adjuvant is added, with stirring to the aqueous phase obtained, the organic phase being present in the aqueous phase in the form of finely distributed droplets in the vicinity of the dispersed particles of the active substance which is present in that phase.

Table 1 hereinbelow gives examples of suspoemulsions according to the invention.

The terms used in the examples which follow (in the case of commercially available products, the manufacturer in question is indicated in brackets) have the following meaning:

| | |
|---|---|
| Bentone ® = | modified layered silicate (Elementis) |
| EO = | ethylene oxide |
| Crafol ® AP 261 = | sodium lauryl ether phosphate (Cognis) |
| Libramul IPA ™ = | isopropylamine salt of dodecylbenzenesulfonic |
| | acid |
| Solvesso ™ 200 ND = | aromatic hydrocarbon (Exxon Mobil Chemicals) |
| | containing <0.5% naphthalene |
| Soprophor ® FL 60 = | tristyrylphenol with 16 EO units, phosphated and |
| | neutralized with triethylamine (Rhodia) |
| Rhodorsil ® 454 = | polydimethylsiloxane (Rhodia) |

TABLE 1
(all data in percent by weight)

| | | Example No. | | | | | | |
|---|---|---|---|---|---|---|---|---|
| | Component | 1 | 2 | 3 | 4 | 5 | 6 | 7 |
| a | Bromoxynil | 9.5 | 9.8 | 10.0 | 20.0 | | 9.8 | 9.5 |
| | octanoate | | | | | | | |
| a | Bromoxynil | 9.0 | 8.8 | 9.0 | | 20.0 | 8.8 | 9.0 |
| | hepatnoate | | | | | | | |
| b | Ethoxylated | 6.1 | 6.0 | 7.0 | 6.5 | 6.5 | 6.0 | 6.5 |
| | tridecyl | | | | | | | |
| | alcohol with | | | | | | | |
| | 10EO units | | | | | | | |
| c | Dodecylben- | 0.3 | 0.4 | 0.4 | 0.5 | 0.5 | | |
| | zenesulfonic | | | | | | | |
| | acid, IPA salt | | | | | | | |
| c | Dodecylben- | | | | | | 0.4 | 0.38 |
| | zenesulfonic | | | | | | | |
| | acid, | | | | | | | |
| | Ca²⁺salt | | | | | | | |
| d | Bentone ® | 0.1 | 0.1 | 0.08 | 0.1 | 0.1 | 0.1 | 0.12 |
| e | Atrazine | | | | | | | 26.0 |
| e | Simazine | | | | | | 25.0 | |
| e | Terbuthyl- | 29.0 | 28.8 | 30.0 | 27.0 | 27.0 | | |
| | azine | | | | | | | |
| f | Solvesso ™ | 6.5 | 6.5 | 8.0 | 7.1 | 7.5 | 7.0 | 6.5 |
| | 200 ND | | | | | | | |
| f | Propylene | 2.9 | 3.0 | 2.5 | 2.4 | 3.0 | 2.5 | 3.0 |
| | glycol | | | | | | | |
| f | Soprophor ® | 2.0 | 2.0 | 2.0 | 2.5 | 2.0 | 1.8 | 2.0 |
| | FL60 | | | | | | | |
| f | Rhodorsil ® | 0.21 | 0.20 | 0.20 | 0.20 | 0.20 | 0.17 | 0.20 |
| | 454 | | | | | | | |
| g | Water | 34.39 | 34.4 | 30.82 | 33.7 | 33.2 | 38.43 | 36.8 |
| | Total: | 100 | 100 | 100 | 100 | 100 | 100 | 100 |
| | | Example No. | | | | | | |
| | Component | 8 | 9 | 10 | 11 | 12 | 13 | 14 |
| a | Bromoxynil | 30.5 | | 28.0 | | 9.9 | 10.0 | 10.0 |
| | octanoate | | | | | | | |
| a | Bromoxynil | | 29.0 | | 27.0 | 8.8 | 9.0 | 9.0 |
| | hepatnoate | | | | | | | |
| b | Ethoxylated | 8.0 | 8.0 | 9.0 | 10.0 | 6.1 | 7.0 | 8.0 |
| | tridecyl | | | | | | | |
| | alcohol with | | | | | | | |
| | 10EO units | | | | | | | |
| c | Dodecylben- | | 0.5 | | | 0.3 | | |
| | zenesulfonic | | | | | | | |
| | acid, IPA salt | | | | | | | |
| c | Dodecylben- | 0.4 | | 0.4 | 0.4 | | 0.25 | 0.3 |
| | zenesulfonic | | | | | | | |
| | acid, | | | | | | | |
| | Ca²⁺salt | | | | | | | |
| d | Bentone ® | 0.1 | 0.1 | 0.1 | 0.08 | 0.1 | 0.1 | 0.1 |
| e | Atrazine | | | | 22.0 | | | |
| e | Simazine | | | 21.0 | | | | |
| e | Terbuthyl- | 20.0 | 20.0 | | | 28.9 | 25.9 | 29.0 |
| | azine | | | | | | | |
| f | Solvesso ™ | 9.0 | 10.0 | 11.0 | 12.0 | 5.7 | 7.0 | 8.0 |
| | 200 ND | | | | | | | |
| f | Propylene | 2.0 | 1.0 | 0.5 | 0.5 | 2.9 | 3.0 | 2.0 |
| | glycol | | | | | | | |
| f | Soprophor ® | 3.0 | 3.0 | 2.5 | 3.0 | 2.0 | 2.0 | 2.0 |
| | FL60 | | | | | | | |
| f | Rhodorsil ® | 0.20 | 0.20 | 0.20 | 0.20 | 0.22 | 0.30 | 0.20 |
| | 454 | | | | | | | |
| g | Water | 26.8 | 28.2 | 27.3 | 24.82 | 35.08 | 35.45 | 31.4 |
| | Total: | 100 | 100 | 100 | 100 | 100 | 100 | 100 |

In comparison with the examples shown in table 1, the formulations shown in table 2 hereinbelow are all found to form agglomerations and to lack flowability.

The distinguishing feature is that the ethoxylated tridecyl alcohol with 10 EO units (=component “b” in table 1) has been substituted for the components Emulsogen EL 400 (=castor oil with 40 ethylene oxide units (EO); Clariant), Soprophor™ CY/8 (=tristyrylphenol with 20 ethylene oxide units (EO); Clariant) and Soprophor™ S 25 (tristyrylphenol with 25 ethylene oxide units (EO); Clariant)—termed “b*” in table 2.

TABLE 2

| | Component | 1 | 2¹⁾ | 3¹⁾ |
|---|---|---|---|---|
| a | Bromoxynil octanoate | 9.8 | 9.8 | 10.0 |
| a | Bromoxynil heptanoate | 9.0 | 9.0 | 9.0 |
| b* | Emulsogen EL 400 | 6.1 | | |
| b* | Soprophor ™ CY/8 | | 6.1 | |
| b* | Soprophor ™ S 25 | | | 6.1 |
| c | Libramul IPA | 0.3 | 0.3 | 0.3 |
| e | Terbuthylazine | 25.3 | 25.3 | 25.3 |
| f | Soprophor ® FL/60 | 2.0 | 2.0 | 2.0 |
| f | Rhodorsil ® 454 | 0.2 | 0.2 | 0.2 |
| f | Propylene glycol | 2.9 | 2.9 | 2.9 |
| g | Water | 44.4 | 44.4 | 44.2 |
| | Total: | 100 | 100 | 100 |

¹⁾according to EP-A-0261492

Chemical Stability of the Suspoemulsions According to the Invention

All of the suspoemulsions according to the invention of examples 1 to 14 in table 1 have outstanding storage stability. At room temperature, they are stable for at least 2 years and at 50° C. for at least 3 months without any noticeable change.

Herbicidal Activity

The herbicidal activity of the suspoemulsions according to the invention and the herbicidal compositions according to the invention against all the important harmful plants in crops of useful plants, for which an activity of the components (a) and/or (e) which are used in each case is known, attains at least the level of the prior-art alkylphenol-polyethoxylate- or naphthalene-comprising (≧0.5%) suspoemulsions which comprise, as agrochemical active substance, at least one hydroxybenzonitrile which is active in plants.

We claim:

1. An oil-in-water suspoemulsion (o/w suspoemulsion) comprising one or more active substances which are active in plants, selected from the group of the hydroxybenzonitriles, the formulations being free of alkylphenol polyethoxylates, and naphthalene being present in an amount of less than 0.5%.

2. The suspoemulsion as claimed in claim 1, comprising
a) 0.1 to 50% of one or more hydroxybenzonitriles which have an effect in plants;
b) 0.1 to 15% of one or more ethoxylated tridecyl alcohols comprising 2-50 ethylene oxide units (EO),
c) 0.01 to 10% of one or more dodecylbenzenesulfonic acid salts,
d) 0.01 to 2% of one or more thickeners,
e) 0.1 to 45% of one or more other agrochemical active substances other than a),
f) 0.1 to 35% of adjuvants and additives, and
g) 20 to 50% of water.

3. The suspoemulsion as claimed in claim 1, comprising
a) 0.5 to 40% of one or more hydroxybenzonitriles which have an effect in plants,
b) 2.0 to 12% of one or more ethoxylated tridecyl alcohols comprising 2-50 ethylene oxide units (EO),
c) 0.1 to 5% of one or more dodecylbenzenesulfonic acid salts,
d) 0.02 to 1.2% of one or more thickeners,
e) 3.5 to 40% of one or more other agrochemical active substances other than a),
f) 0.15 to 12% of adjuvants and additives, and
g) 20 to 50% of water.

4. The suspoemulsion as claimed in claim 1, comprising
a) 0.5 to 32% of one or more hydroxybenzonitriles which have an effect in plants,
b) 4 to 10% of one or more ethoxylated tridecyl alcohols comprising 2-50 ethylene oxide units (EO),
c) 0.2 to 2% of one or more dodecylbenzenesulfonic acid salts,
d) 0.05 to 0.8% of one or more thickeners,
e) 3.5 to 40% of one or more other agrochemical active substances other than a),
f) 0.15 to 12% of adjuvants and additives, and
g) 20 to 50% of water.

5. The suspoemulsion as claimed in claim 1, wherein component a) corresponds to a bromoxynil or an ioxynil.

6. The suspoemulsion as claimed in claim 1, wherein the ethoxylated tridecyl alcohol (component b)) consists of 3-20 ethylene oxide units (EO).

7. The suspoemulsion as claimed in claim 1, wherein the ethoxylated tridecyl alcohol (component b)) consists of 4-12 ethylene oxide units (EO).

8. The suspoemulsion as claimed in claim 1, wherein the thickener (component d) corresponds to a modified natural silicate.

9. The suspoemulsion as claimed in claim 1, wherein the thickener (d) corresponds to a modified bentonite.

10. The suspoemulsion as claimed in claim 1, wherein the agrochemical active substance (e) which is other than a) corresponds to an active substance from the group of the 1,3,5-triazines or the 1,2,4-triazinones.

11. The suspoemulsion as claimed in claim 1, wherein the agrochemical active substance (e) which is other than a) corresponds to an atrazine.

12. The suspoemulsion as claimed in claim 1, wherein the agrochemical active substance (e) which is other than a) corresponds to a terbuthylazine.

13. A process for the preparation of a suspoemulsion as claimed in claim 1, wherein the components are mixed, and if appropriate, ground.

14. A method of controlling undesired vegetation, wherein an effective amount of a suspoemulsion as claimed in claim 1 is applied to the plants, parts of the plants, the seeds or the area on which the plants grow.

15. A method of use for a suspoemulsion as claimed in claim 1 for controlling undesired vegetation.

16. A method of use for a suspoemulsion as claimed in claim 1 for the preparation of a herbicidal composition.

17. A liquid herbicidal composition, obtainable by diluting an aqueous dispersion as claimed in claim 1.
